(19) United States
(12) Patent Application Publication
(10) Pub. No.: US 2004/0034832 A1
(43) Pub. Date: Feb. 19, 2004

(54) Method and apparatus for foward annotating documents

(75) Inventors: Alex S. Taylor, Guilford (GB); Ercan E. Kuruoglu, Pisa (IT)

Correspondence Address: OLIFF & BERRIDGE, PLC., P.O. BOX 19928, ALEXANDRIA, VA, 22320, US

(73) Assignee: XEROX CORPORATION, Stamford, CT

(21) Appl. No.: 09/981,835

(22) Filed: Oct. 19, 2001

(51) Int. Cl. G06F 15/00

(52) U.S. Cl. 715/512; 715/526

(57) ABSTRACT

A target document in a document processing system is annotated on the basis of annotations made previously to a source document. A source document (either a scanned image of a paper document or an electronic document) is annotated by a user to identify words or phrases of interest. The annotated words are extracted for use as keywords or phrases to search in future document. When a target document is processed, the target document is searched to locate any of the keywords of interest to the user. If any of the keywords are located, electronic annotations are applied to these in the target document for display or printing out and/or registered as keywords to the project. The automatically annotated words or phrases enable the user to locate regions of interest more quickly.

### CROSS-REFERENCE TO RELATED APPLICATIONS

Cross-reference is made to U.S. patent application Ser. No. 09/AAA,AAA, entitled “Method And Apparatus For Generating A Summary From A Document Image” (Attorney Docket No. D/A0606), which is hereby incorporated herein by reference.

### BACKGROUND OF THE INVENTION

1. Field of the Invention

The present invention relates to the field of processing documents. The invention is especially suitable for, but not limited to, processing captured images of documents.

2. Description of Related Art

There are many situations in which a person has to read several documents, looking for the same information in each document. This is very time consuming and the user may be likely to miss or overlook important information buried in other text.

It would be desirable if a document to be read could be somehow marked automatically to draw a user's attention to certain portions of the document which may contain significant information, irrespective of the type or format of the document.

### SUMMARY OF THE INVENTION

The present invention provides a technique in which a target document is annotated on the basis of one or more keywords previously entered into the processing system.

In more detail, the target document is searched to identify the occurrence of the one or more keywords, and any such occurrences are annotated (with an electronically generated annotation) to guide the user to such text.

The term annotate is intended to be interpreted broadly, and may include any suitable marking (e.g., highlighting, circling, crossing through, bracketing, underlining, bolding, italicizing, or coloring) or other technique for visually indicating a section of the document.

Preferably, the keywords are derived from a source document which has been previously annotated by a user. The system may thus be referred to as a “forward annotation” system for automatically “forwarding” annotations made to a source document into equivalent annotations of a target document.

Preferably, the source document may be either a paper (or other physical) document, or an electronic document (e.g., a text file).

Preferably, the target document may be either a paper (or other physical) document, or an electronic document (e.g., a text file or image of the document).

Preferably, the system comprises a project storage device for storing keywords from a plurality of source documents.

Preferably, the storage device also stores the complete source documents (either in electronic text form, or as a scanned image).

### BRIEF DESCRIPTION OF THE DRAWINGS

These and other aspects of the invention will become apparent from the following description read in conjunction with the accompanying drawings wherein the same reference numerals have been applied to like parts and in which:

FIG. 1 is a block diagram showing a document processing system;

FIG. 2 is a schematic diagram illustrating the operating principles of the system;

FIG. 3 is a schematic illustration of an example process;

FIG. 4 is a schematic flow diagram illustrating an input method; and

FIG. 5 is a schematic flow diagram illustrating an output method.

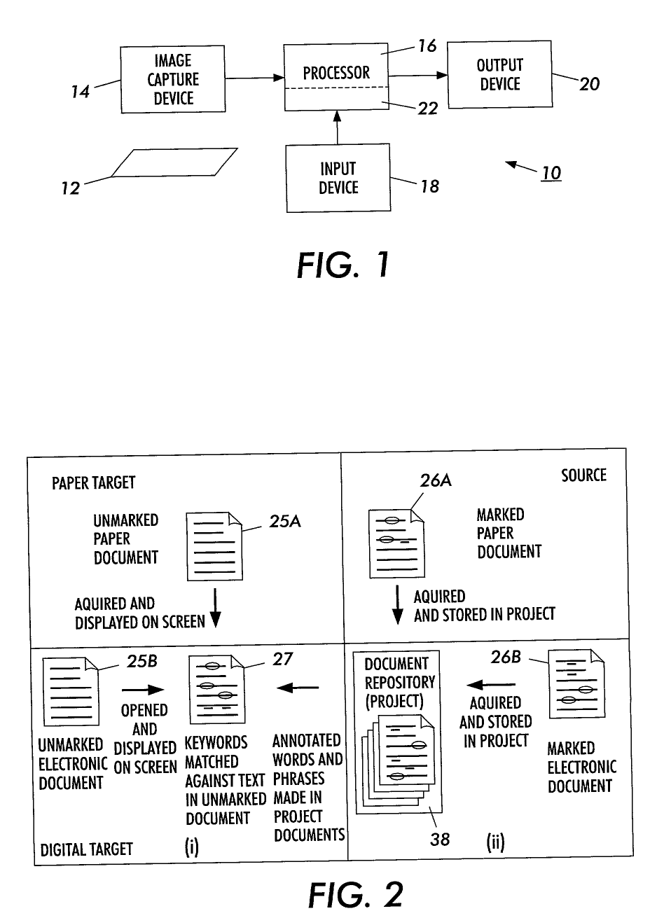

### DETAILED DESCRIPTION

Referring to the drawings, a document processing system 10 comprises an image capture device 14 for capturing a digital image of a document 12. The image capture device may for example comprise a flatbed scanner, or a desktop camera-based scanning device.

The system further comprises a processor 16 for processing the image, one or more user input devices 18, for example, a keyboard and/or a pointing device, and one or more output devices 20, for example, an output display and/or a printer.

The processor comprises 16 a mass storage device 22 which may, for example, be implemented with any suitable memory media, such as magnetic media, optical media, or semiconductor media.

Referring to FIG. 2, the function of this embodiment is to automatically annotate a “target” document 25 which a user may desire to read, to indicate regions of interest based on previously stored annotations from other “source” documents 26. The system produces an annotated target document 27 that is based on external annotations previously made by the same user (or other users) to one or more previous documents 26. The system may thus be referred to as a “forward annotation” system.

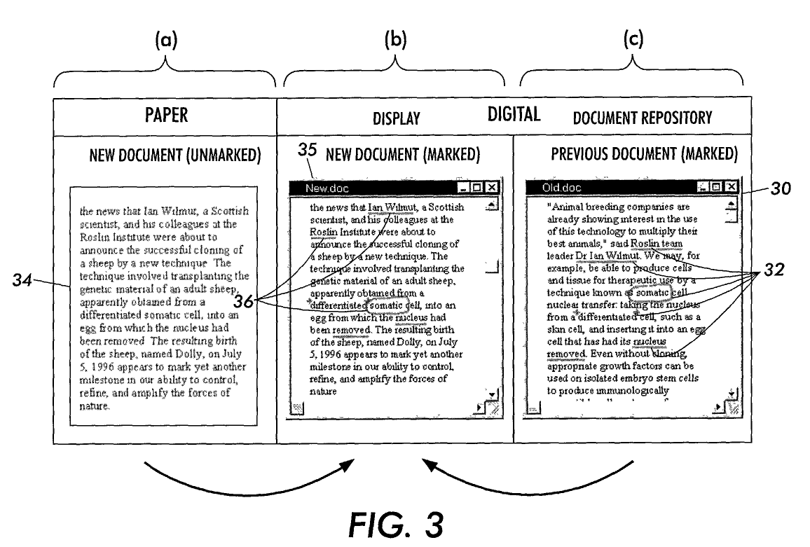

One example of this is illustrated in FIG. 3. FIG. 3(c) shows a source document 30 which has been annotated on paper by a user to represent the useful text 32 which the user wishes to identify in future target documents. The document 30 is scanned into the processing system 10, which processes the scanned image to identify the annotated text (described in more detail below).

FIG. 3(a) illustrates a target paper document 34 which the user now wishes to read. At this stage the target document is plain (i.e. it contains no annotations to guide the user to the significant text). The target document 34 is scanned into the processing system which then processes the scanned image to identify whether any of the previously annotated words 32 are present in the target document. If they are, then the same words appearing in the target document 34 are annotated (within the digital image 35 of the target document 34) to be given the same annotations 36 as the source document 30, as illustrated in FIG. 3(b). The annotated target document can then be displayed or printed out for the user to read.

Referring again to FIG. 2, the processor 16 maintains a library or repository of the data or images from each source document, in the form of a project 38. Each project 38 can include a plurality of documents or annotations from different documents. The project may either contain document images, or it may contain data representing the identified annotations.

In this embodiment, the source documents are not limited only to paper documents, but may include electronic versions of a document, such as a text file or a word-processing file. In this case, the annotations in the electronic source document may be made by any suitable technique, including, for example, underlining, highlighting or insertion of markers. In addition, the annotations in the electronic source document may include a variety of data formats such as image, video, audio, graphic, and textual.

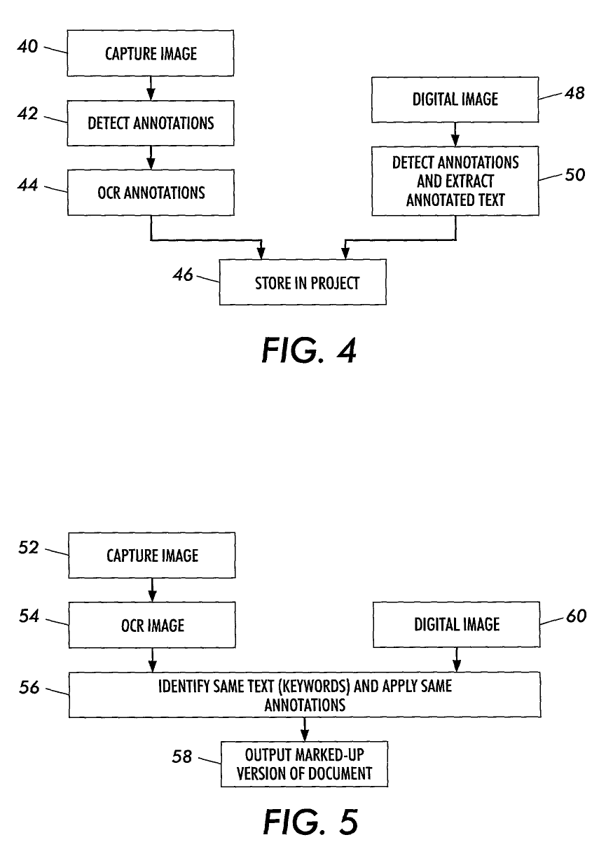

FIG. 4 shows a technique for inputting source documents into the processing system 10. At step 40, a paper document (including paper annotations) is scanned using the capture device 14 to generate a digital image of the document.

At step 42, the paper annotations are identified in the scanned image. Techniques for identifying annotations are known to one skilled in the art, and so need not be described here in detail. However, as an example, U.S. Pat. No. 5,384,863, which is incorporated herein by reference, describes a suitable system for discriminating hand written annotations from machine printed text.

At step 44, the text corresponding to the annotated regions is processed by an optical character recognition (OCR) algorithm to convert that region (text) into electronic text. This performed in the present embodiment as an optimum technique for identifying the same text in later target documents (especially electronic target documents). However, it will be appreciated that if desired a bitmap of the annotated text may be extracted instead, and the annotation used as a source in bitmap form.

At step 46, the extracted text (OCR text of bitmap) is stored in the project 38 together with data representing the type of annotation (for example, underlined or highlighted or ringed, etc.). The text is thus treated as a keyword or key-phrase for use in searching of future target documents.

As mentioned above, if desired the entire document (rather than merely the keywords or key-phrases) can be stored in the project 38. However, the keywords or key-phrases are stored as the text for future searching.

If the source document is an electronic document, then this is inputted electronically instead at step 48. The electronic document is processed at step 50 to identify and extract annotated regions of the document, and such annotations are then stored at step 46 in the same manner as described above.

Using this method it is possible to build up a project 38 comprising one or more documents containing annotations indicative of text of interest to the user.

FIG. 5 illustrates a technique for processing target documents to apply the same annotations as made in the source documents. If the target document is a paper document, this is scanned at step 52 to form a digital image using the capture device 14.

At step 54, the digital image is processed using an OCR algorithm to convert the scanned image into electronic text.

At step 56, the electronic text is searched to identify whether any of the previous annotations stored in the project 38 are present in the target document. If they are, then equivalent annotations (in electronic form) are applied to the electronic text.

At step 58, the annotated target document is outputted for display or for printing.

If the target document is an electronic document, then this is inputted instead at step 60 for direct processing at step 56.

If desired, the user may have the option to selectively edit, manipulate or delete annotations made to both marked (source) documents and to unmarked (target) documents.

If desired, the system may be enabled or disabled to detect frequently used words (less stop words), automatically annotate the document, and register the frequently used words as keywords to the project.

If desired, once a document has been processed at step 56, the document may be stored as part of the project 38. In this case, the project would store a complete representation of the document, rather than merely the extracted annotations (keywords or key-phrases). The document can then be retrieved for display simply by clinking on an annotation in another document stored in the project.

In this embodiment, the OCR processing of scanned images can enable annotations made to paper source documents to be used for annotating electronic target documents, and also annotations made to electronic source documents to be used for annotating paper target documents. Additionally, it can also compensate for different character fonts and character sizes in different paper documents. However, if this versatility is not required in other embodiments, then the principles of the invention may be used without OCR, for example in a system which only processes electronic documents (source and target) or in a system which only processes paper documents (source and target).

Additionally, although this embodiment simply annotates a target document based on one or more source annotations, other embodiments may employ the annotations in other ways. For example, the invention may be combined with the summary generation technique described in U.S. patent application Ser. No. 09/AAA,AAA, entitled “Method And Apparatus For Generating A Summary From A Document Image” (Attorney Docket No. D/A0606), which is hereby incorporated by reference. In such a combined technique, a target document could be automatically summarized based on annotations made previously to a different source document.

The invention has been described with reference to a particular embodiment. Modifications and alterations will occur to others upon reading and understanding this specification taken together with the drawings. The embodiments are but examples, and various alternatives, modifications, variations or improvements may be made by those skilled in the art from this teaching which are intended to be encompassed by the following claims.

1. A system for processing a target document, the system comprising:
a storage device for storing a plurality of words;
a search device for identifying whether any of the words present in the storage device are present in the target document; and
an annotation device for annotating said words located in the target document.

2. A system according to claim 1, further comprising an input device for inputting words from a source document into the storage device, the input device comprising:
a detector for detecting one or more annotated regions in the source document; and
a device for entering one or more words from a detected annotated region of the source document into the storage device.

3. A system according to claim 2, wherein the input device further comprises a capture device for capturing a digital image of a physical source document.

4. A system according to claim 3, wherein the detector is operable to detect annotations in the captured image of the source document.

5. A system according to claim 4, wherein the detector is operable to detect a type of annotation.

6. A system according to claim 5, wherein the type of annotation comprises one of highlighting, underlining, circling, crossing through, bracketing, bolding, italicizing, and coloring.

7. A system according to claim 1, further comprising a capture device for capturing a digital image of a physical target document to be annotated.

8. A system according to claim 1, wherein the annotation device is operable to annotate one or more words in the target document using the same type of annotation as used in a source document from which the words in the storage device are derived.

9. A method of processing a target document, comprising:
storing a plurality of words of interest;
searching the target document to identify whether any of said words of interest are present in the target document; and
annotating said words located in the target document.

10. A method according to claim 9, further comprising inputting words from a source document into the stored words of interest.

11. A method according to claim 10, further comprising detecting one or more annotated regions in the source document, and entering one or more words from a detected annotated region of the source document into the stored words of interest.

12. A method according to claim 10, further comprising optically capturing a digital image of a physical source document.

13. A method according to claim 11, wherein said detecting comprises detecting annotations in a captured image of the source document.

14. A method according claim to 13, wherein said detecting comprises detecting a type of annotation.

15. A method according to claim 14, wherein the type of annotation detected comprises one of highlighting, underlining, circling, crossing through, bracketing, bolding, italicizing, and coloring.

16. A method according to claim 9, further comprising optically capturing a digital image of a physical target document to be annotated.

17. A method according to claim 9, wherein said annotating comprises annotating one or more words in the target document using the same type of annotation as used in a source document from which stored words are derived.
